(19) United States
(12) Patent Application Publication
(10) Pub. No.: US 2014/0000522 A1
(43) Pub. Date: Jan. 2, 2014

(54) AUTOMATIC FEED DISPENSER

(71) Applicant: Anders Christensen, Holbaek (DK)

(72) Inventor: Anders Christensen, Holbaek (DK)

(73) Assignee: ASTUTE A/S, HOLBAEK (DK)

(21) Appl. No.: 13/996,868

(22) PCT Filed: Oct. 12, 2011
(86) PCT No.: PCT/DK11/50382

§ 371 Date: Sep. 20, 2013

(30) Foreign Application Priority Data
Dec. 22, 2010 (DK) PA2010 01177

(51) Int. Cl. A01K 5/02; A01K 11/00

(52) U.S. Cl. CPC A01K 5/0208; A01K 5/02; A01K 11/006
USPC 119/51.02; 119/57.92

(57) ABSTRACT

A method for automatically feeding at least two animals wherein at least one feed dispenser is used which comprises at least one registration device, an electronic control unit, a feed container, a conveyor mechanism, a trough, said at least two animals being each provided with an information carrier containing data, wherein the method comprises the following steps: the information carrier is registered via registration device; the control unit activates the conveyor mechanism which advances feed to the trough, wherein said control unit activates the conveyor mechanism to the effect that the conveyor mechanism advances a varying amount of feed per time unit depending on the registered information carrier; said control unit stopping the conveyor mechanism when registration of information carrier is interrupted whereby dispensing of feed is stopped.

The present invention relates to a method for automatically feeding at least two animals, wherein at least one feed dispenser is used that comprises at least one registration device, an electronic programmable control unit with memory, a feed container, a conveyor mechanism, a trough, said at least two animals being each provided with an information carrier containing data, whereby said method comprises the following steps: information carrier is registered via registration device; the control unit activates the conveyor mechanism advancing the feed from feed container to the trough.

The invention further relates to a feed dispenser comprising at least one registration device, an electronic programmable control unit with memory, at least one feed container, at least one conveyor mechanism, a feeding site comprising a trough, wherein the one or more conveyor mechanisms is/are capable of advancing feed from one or more feed containers to the trough, said feeding site being arranged in such a way as to provide an animal with an escapeway during the entire feeding process thereby enabling the animal to leave the trough at any time.

### DESCRIPTION OF THE PRIOR ART

In modern farming, high-tech plants are used to an increasing extent to increase efficiency with ensuing minimisation of fixed-asset investments. Thus, it has become very common to use a control unit and information carriers, eg in the shape of tags, transponders, responders or the like, for registering animals kept in herds, but needing individual feed, treatment and the like.

By comparing information from the information carrier to information stored in a central control unit, it becomes possible to ensure individual handling in the shape of feeding, milking of cows, separation from herd, etc. Hereby the need for manual monitoring and handling of the animals is reduced.

In an example of this description, starting point is taken in the feeding of pigs, but the automatic feeding may also be feeding of sheep, horses, cattle, goats and other livestock, and the automatic feeding may take place indoors as well as outdoors.

Pigs have a strong hierarchy and when the animals are hungry, they fight for their feed in an attempt to appropriate each other's feed. Earlier on, that problem was solved by the individual animal being separated from the herd, or in other way separating the individual animal off by gate, whereupon the animal was given feed, thereby enabling it to eat its portion of feed in peace and calm. Typically, the animal is given a relatively large portion and in some cases a full daily ration.

### DESCRIPTION OF THE INVENTION

It is the object of the invention to provide a method for automatically feeding animals to the effect that feeding errors are minimised and that the animals fight minimally for their feed.

According to the present invention it is accomplished by a method of the type described above which is characterised in that the control unit activates the conveyor mechanism to the effect that the conveyor mechanism advances an amount of feed per time unit depending on the registered information carrier; the control unit brings the conveyor mechanism to a halt when registration of the information carrier is interrupted to the effect that dispensing of feed is discontinued when an animal leaves the trough.

Hereby the feed can be portioned in accordance with the eating velocity of the animal, and thereby it can be ensured that the feed dispensed to a specific animal is indeed eaten by that animal, and that the animal has sufficient time for eating the dispensed feed, before the animal is chased away from the trough, should that be the case.

Moreover, the method further ensures that the animal's access to feed resembles the animal's natural eating behaviour. It will be possible for the animals to eat at the time of the day when they wish to do so, and the feed dispenser ensures that the animals cannot receive their feed ration during a short period of time; for instance, a 24-hour ration can be dispensed by way of many small portions during a 24-hour period.

Fighting will be minimal, and a calmer herd ensues.

Amount of feed per time unit can be set forth as a volume as well as a mass of feed.

An embodiment of the invention consists in that the method comprises that the conveyor mechanism continuously advances an amount of feed per time unit depending on the registered information carrier. Hereby an adjusted amount of feed is accomplished to the effect that the animal wearing the registered information carrier has the time available which is necessary for it to eat the dispensed amount of feed.

An embodiment according to the invention consists in that the conveyor mechanism advances feed in portions of varying amounts of feed depending on the registered information carrier.

According to an embodiment of the invention, the method further comprises that the conveyor mechanism advances feed in portions at varying time intervals depending on the registered information carrier.

An embodiment of the invention consists in that the method further comprises that the conveyor mechanism advances a fixed amount of feed per time unit depending on the registered information carrier.

An embodiment of the method consists in that the control unit controls the conveyor mechanism such that conveyance of feed stops when maximal feed dispensing per time unit for an information carrier has been reached. Hereby it is accomplished that an animal does not receive more feed than the maximal amount of feed laid down in the feed regimen.

An embodiment of the method consists in that the control unit introduces a period of discontinued conveyance of feed in case of repeated shifts in registration of information carrier at a trough within a predetermined period of time. Hereby it is accomplished that calm is established at the trough before a portion of feed is dispensed, and thereby feeding errors are obviated. A so-called conflict delay is accomplished.

An embodiment according to the invention consists in that the feed dispenser comprises at least two feed containers and at least two conveyor mechanisms, wherein the method further comprises the following steps: that the control unit advances feed via two or more conveyor mechanisms to a feed trough. Hereby it is accomplished that the feed composition can be adapted individually and as needed by combining several types of feed sources or to accomplish more feed storage and hence increase the capacity of the automated feeding.

An embodiment according to the invention consists in that the memory of the control unit is stored on a central server. Hereby it is accomplished that there is less need for technology and hence less energy is needed which is particularly advantageous. The control unit may be battery-operated which is advantageous when the feed dispenser is deployed on a field for use in the feeding of free-range animals. The transport of information between the control unit and the central server may be wireless.

According to an embodiment of the method, the method further comprises that conveyance of feed to one information carrier takes place asynchronously at a minimum of two independent troughs.

Most animal groups will naturally eat in accordance with the hierarchy of the herd; it coming naturally to most of those being of a low standing in the hierarchy to leave the trough before problems occur, they will visit the feed dispenser at some other occasion when an animal higher up in the hierarchy has eaten, wait until there is room at the trough or will visit another trough. Hereby further conflict handling is accomplished as a pig may continue eating by visiting another trough.

Another aspect of the invention relates to a feed dispenser comprising at least one registration unit, an electronic programmable control unit with memory, at least one feed container, at least one conveyor mechanism, a feeding site comprising a trough, wherein the one or more conveyor mechanisms is/are capable of advancing feed from one or more feed containers to the trough, wherein the feeding site is arranged in such a way that an animal has an escapeway during the entire feeding process, thereby enabling the animal to leave the trough at any time.

According to an embodiment of the feed dispenser according to the invention, the feed dispenser has an interrupter mechanism allowing the control unit to interrupt the conveyor mechanism.

### BRIEF DESCRIPTION OF THE DRAWING

The invention will now be described in further detail with reference to the accompanying drawing, wherein

FIG. 1 shows a flowchart for feeding in accordance with the invention;

FIG. 2 shows a flowchart for accept of feeding;

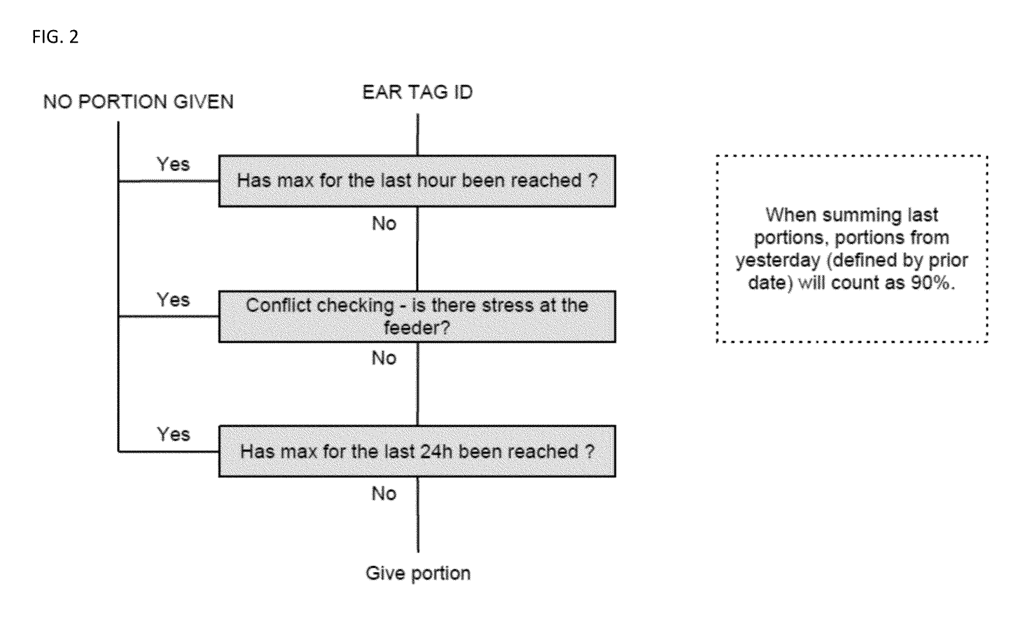

FIG. 3 shows timelines for feeding in portions at varying time intervals depending on the registered information carrier.

### DETAILED DESCRIPTION OF THE INVENTION

The invention relates to a method for automatically and individually feeding animals; in this application, explanations about an automatic feed dispenser for free-range pigs are used, but, of course, the automatic feed dispenser can also be used for other animals, eg horses, sheep, cattle, goats and other livestock, indoors as well as outdoors. The feed dispenser can also be used for feeding a herd of at least one or more different species of animals.

The method comprises a feed dispenser with a registration unit, a programmable control unit with memory, a feed container, a conveyor mechanism, a trough and an information carrier worn by an animal.

For instance, the registration device may be an antenna capable of capturing a signal from a transponder. It is possible to use different types of information carriers. However, it may be advantageous to use transponders as they may be active and be configured eg for emitting a signal indicating to the animal that it will now be accepted for feeding.

All the pigs in a herd will be provided with an information carrier, such as an electronic ear tag/transponder that can be captured by a registration device, eg an antenna. When a pig is within a specific detection range of the trough, the signal will be conveyed from registration unit to the control unit. The pig is identified, and various calculation processes are performed to determine how much feed the pig has already ingested, and whether it is entitled to further feed, and so on. If the pig has not eaten its entire ration in accordance with the individual feeding regimen, the control unit will activate the conveyor mechanism for allocating a portion of feed to the identified pig.

If an animal has been accepted for receiving a feed portion, the conveyor mechanism will allocate a feed portion per time unit to the effect that the advanced feed portion is smaller than the eating velocity of the animal whereby the animal has sufficient time to eat the advanced feed continuously and thereby does not leave any feed behind in the trough.

Dispensing of feed to the effect that the advanced feed portion is smaller than the eating velocity of the animal can be obtained in a number of different ways. The advanced amount of feed per time unit can be adjusted by the size/amount of the advanced feed or the velocity when dispensing the feed being varied, or by a combination thereof.

For instance, feed can be advanced continuously or the feed can be advanced in small portions at intervals. Moreover, the size of the portions can be varied between large or small portions, and by adjustment of one or more of such parameters the conveyor mechanism may advance an amount of feed per time in response to the registered information carrier.

Thus, for instance, it is possible to dispense large amounts of feed at the onset of the visit, the animal being more hungry and inclined to eat faster, which may be accomplished is by initially dispensing large portions that are gradually reduced, or it may be done by gradually increasing the time between dispensing of several equal portions. Portion size per time unit is laid down in a feed regimen for the individual animal.

The feed regimens may be stored in the memory of the control unit.

The memory of the control unit may also be stored on a central server or other unit to the effect that data can be stored and accumulated outside the control unit on the central server. Thereby the central server may store and process the continuously incoming data in re dispensed portions and perform calculation of the amount of remaining feed rations for each information carrier distributed over time.

It will be possible to determine the behaviour of the individual animal by analysing data in re the feed dispensing, eating cycle and visit cycle.

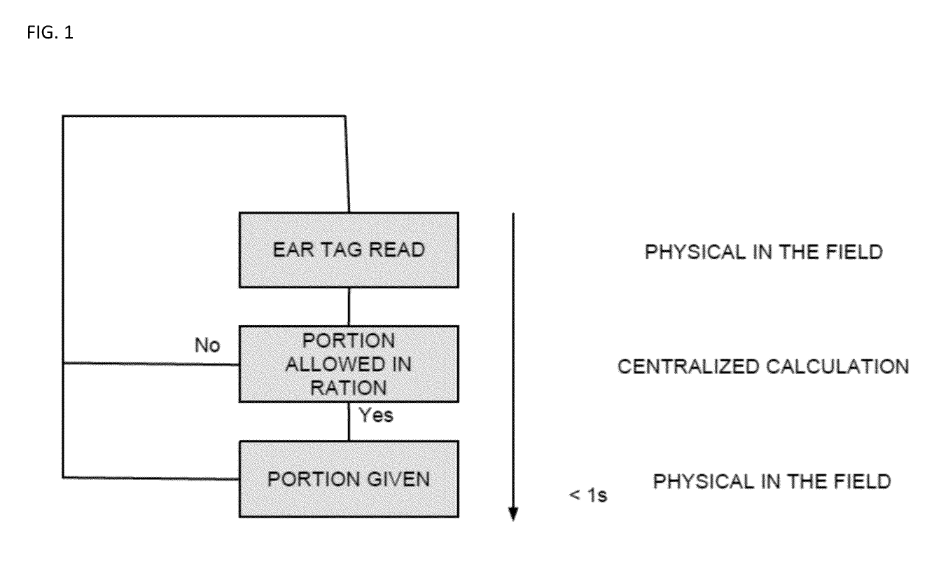

FIG. 1 shows a simple flow chart showing determination of whether or not a feed portion is dispensed.

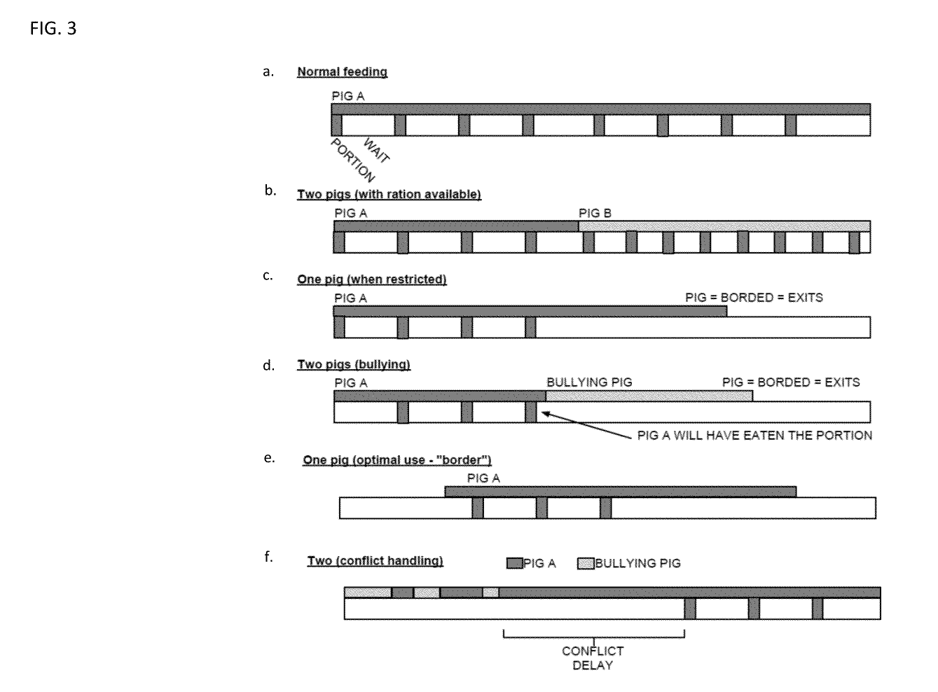

When an information carrier is identified, the feeding process is initiated as shown in FIG. 1 where it is first determined whether maximal feed intake has been reached during a predefined period, eg the last hour. If that is not the case, it is determined whether there is a stress situation at the feed trough as illustrated in FIG. 3f. If that is not the case either, it is determined whether maximal feed intake has occurred for yet a predetermined period, eg 24 hours, ie a 24-hour ration. If that is not the case either, feed dispensing is accepted for the registered information carrier.

When allocated feed portions are accumulated, yesterday's feed portions will partake in the calculations by eg 90% of the total feed amount. That means that yesterday's feed portions do not weigh so much in calculations that the time for allocating the next 24-hour ration is not shifted. The calculation thus ensures that it is enabled that an animal having a very precise eating cycle receives feed eg every morning at the same hour.

The control unit or the central server comprises individual feed regimens for all animals in a herd. It is a common feather of such individual feed regimens that the feed is dispensed slowly or as small meals, as so-called micro-portions distributed throughout a full 24-hour period. Thereby the pigs have the time necessary for eating the dispensed feed before they are chased away by another individual in the herd, thus obviating feeding errors.

FIG. 3a shows a timeline where pig A receives a feed portion of fixed size at equal time intervals. That means that, for as long as pig A is registered at the trough, feed is dispensed at the fixed time intervals shown in the example. In FIG. 3b, pig A leaves the trough after four dispensed feed portions, and pig B subsequently uses the trough and receives feed at shorter, equal time intervals.

When pig A has received a maximal feed amount for a period of time, pig A does not receive further feed portions, and the conveyor mechanism stops the conveyance of feed to the trough as illustrated in FIG. 3c.

The dispensing of feed to Pig A may also be interrupted if another pig intrudes, see FIG. 3d. However, the dispensed portion will be so small that pig A will have emptied the trough before it leaves the trough.

FIG. 3f shows that the information carriers for two pigs that are alternatingly registered at the trough within a predetermined time interval is a sign of commotion at the trough, and in order to establish calm at the eating trough, an intermission is made in the dispensing of feed, a so-called conflict delay.

The structure of a feed dispenser can be made in a vast number of ways.

For instance, the feed dispenser may consist of a feeding site with a trough. The feeding site may have a U-shaped shielding, a so-called stall. The stall may be of such size as to accommodate only one animal at a time to the effect that there is space for the identified animal only and hence that the identified animal only has access to the trough. However, there is no gate behind the animal.

The feed plant may be of modular structure to the effect that an adjoining second module may contain a feed container.

It is thus also possible to provide several feed containers with feed associated to one feeding trough whereby it is possible to combine different types of feed or merely to increase the capacity of the feed dispenser.

By providing two or more feed dispensers, one may individually adapt and mix the feed per animal with information carrier. That can be used actively to minimise conflicts in that the animals that are too active receive a less energy-rich feed mixture.

The present invention relates to an automatic feed dispenser for use in the feeding of animals, primarily pigs, but also sheep, horses, cattle, goats and other livestock.

The automated dispensing of feed is initiated by the animal being identified in a commonly known manner via a transponder which is an electronic ear tag based on RFID technology.

The principle consists of:
1. feeding in small portions, much smaller than conventional portion-feeding, as small as portions of 5-10 grams (micro-portions);
2. being able to individually adjust weight, mixture ratios and nutrition contents;
3. having the option of adjusting the time automatically between dispensing of portions relative to the eating velocity of the animal; and
4. thus obviating the need for an entry gate.

Allocation of the number of portions takes place in such a manner that the animal's overall requirements per 24-hour period are covered. The dispensing resembling, in principle, the animal's natural access to feed, the animal will also access the feed source/the feed dispensing in accordance with that animal's natural instincts. This means that conflicts are resolved “ naturally.

The micro-portions and the portioning thereof ensure that the animal currently eating will always have time enough to eat the small amount already dispensed into the eating trough before another animal intrudes. This means that that no “rewards” are obtained from dislodging a weaker animal from the feed dispenser. If the animal is still there after a specified period of time (between the micro-portions), dispensing of another feed portion will occur. The feeding will continue in this manner, until the software has calculated a stop.

If two pigs take turns to feed and are registered at short intervals at the trough, a conflict delay may be incorporated into the software. Thereby feed is not dispensed into the trough until a condition of calm is once again established at the trough.

In the feed portioning, both weight and volume of feed are of consequence to the feeding.

In order to ensure correct dosing of energy, but also of volume, to establish a feeling of satiety in the animal, it is advantageous to provide two or more feed sources to the effect that the feed composition may be further adapted to the individual animal.

Software continuously analyses feeding data and adjusts the interval between the micro-portions to the effect that the eating velocity is adjusted dynamically. Thereby optimal operation of the dispenser is ensured. The micro-feeding mimics/imitates the animal's natural access to feed in the wild, and that means that the principle is useful for free-range production and for animals in the wild.

Since the dispenser does not feature an entry gate ensuring, in a conventional feed dispenser, that only one animal at a time is present, the present dispenser can be used for animals that are not of the same length/width, type or race.

Several feed screws (conveyor mechanisms) can be combined to the effect that they dispense to the same individual. Thereby the feed dispensed can be admixed from several feed sources. That may contribute to ensuring the capacity and use/efficiency of the invention; in particular in respect of the “no gate” principle.

If an animal is too eager to access the dispenser, a feed source with very low energy content can be dispensed to that animal, or a suitable mixture ratio can be made. Thereby the animal will have a full belly and be less eager.

Correct dispensing and limitation of the micro-portions contribute to ensuring optimal utilisation of feed and ensures good stomach/rumen health.

Today, portioned feeding is known and it is, roughly speaking, a simple mechanical solution to the practical task of feeding. The portions are large. That means that the entire 24-hour ration of the animal is divided into 2-5 portions, and that the animals are restricted by means of a gate during the feeding. The differences between the present invention and the existing systems are:
1. dispensing of feed occurs in micro-portions versus dispensing in large portions;
2. option of feed mixtures per individual versus one feed source;
3. optimisation of eating time versus no optimisation; and
4. no entry gate versus use of entry gate.

The primary technical function of the invention ensures that a cumbersome entry gate becomes superfluous, and that the eating velocity is adjusted dynamically, which ensures an optimisation of the possible number of animals being fed via the dispenser.

The conveyor mechanism and trough can be configured in several ways, see below for an example.

The portioning mechanism for feeding comprises a conventional screw driven by a stepping motor. The motor is connected to the screw via a drive means. A correctly dimensioned pin ensures that the feed source is stirred continuously, and hence no operation stopping “bridges” are formed in the feed that would otherwise inhibit the functioning of the screw, and thus ensures the uniformity of portioning. The length of the screw is adapted such as to enable it to introduce precisely the amount for which it is dimensioned.

The dosing of the portions is accomplished via a conventional screw. The screw may be a screw feeder, an auger conveyor, etc. The screw is of a small type, ie the diameter is small, and the pitch is relatively low. The driving force as such that makes the screw perform the portioning is a motor. The motor will be activated such that the desired portioning is made. This is technically constructed today.

A screw is conventionally mounted with an inclination and hence lifts up the feed. It is very energy-consuming to lift up the feed. Therefore, in that case, the screw is deployed vertically to ensure an energy-efficient solution.

The screw moves feed from the one end of the screw to the other, where the feed is to be dispensed. The motor for the screw is a stepping motor which is controlled by electric impulses.

A calibration is to clarify how many grams are transported per step for a given feed source. The clarification takes place either via internal scales or external, temporary scales. The scales may be positioned between screw and feeding trough to know the accurate portion size.

To ensure that further feed does not drop from the screw feeder when the animals shake the dispenser, the screw is reversed following feeding. Hereby the feed is pulled back into the screw.

The technical solution described above ensures against any excess feeding, ie overdosing of feed in case of system errors or other failure.

The construction contributes to ensuring that the portion has the same accuracy in case of instable power sources, and the energy efficiency ensures the longest possible operating time on eg a charged storage battery for cars.

The construction ensures that it is possible to portion very small-sized portions with a tolerance which is very low. The vertical screw ensures that meal feed, feed with varying humidity/quality, and feed with foreign objects can be used and thus do not contribute to operation stoppages.

A very large portion of the screw is open for access of the feed in the subjacent silo, ensuring a good grip of the feed.

Automatic feed dispenser for use in the feeding of animals via transponder, wherein the feed portions are divided into micro-portions, which contributes to rendering entry gates superfluous.

The automatic feed dispenser is configured without entry gates.

The time elapsing between the micro-portions may be adjusted dynamically in accordance with eating capacity, and hence the eating capacity may be adjusted automatically through software calculation/analysis of data.

The portioning takes place via a stepping motor.

The portioning screw is mounted almost vertically.

The feed dispenser is also capable of dispensing wet feed.

The feed dispenser is capable of dispensing while admixing from several sources (screw feeder systems) mounted such as to be able to be combined for feeding of one single animal.

1. A method of automatically feeding at least two animals, wherein at least one feed dispenser is used that comprises at least one registration device, an electronic programmable control unit with memory, a feed container, a conveyor mechanism, a trough, said at least two animals sharing said trough and said at least two animals being each provided with an information carrier containing data, whereby said method comprises the following steps:
the information carrier is registered via the at least one registration device;
the electronic programmable control unit identifies the animal and activates the conveyor mechanism advancing the feed from feed container to the trough;
said electronic programmable control unit comprising individual feed regimens for said at least two animals, a common feature of said individual feed regimens is that the feed is dispensed slowly or as small meals;
the control unit activates the conveyor mechanism to the effect that the conveyor mechanism advances an individually amount of feed per time unit depending on the registered information carrier, said feed being portioned in accordance with the eating velocity of the identified animal, as long as the information carrier is registered at the trough; and
the control unit stops the conveyor mechanism when registration of the information carrier is interrupted to the effect that dispensing of feed is discontinued when an animal leaves the trough.

2. A method according to claim 1, wherein the method further comprises the following step:
the conveyor mechanism continuously advances an amount of feed per time unit depending on the registered information carrier.

3. A method according to claim 1, wherein the method further comprises the following step:
the conveyor mechanism advances feed in portions with varying feed amounts depending on the registered information carrier.

4. A method according to claim 1, wherein the method further comprises the following step:
the conveyor mechanism advances feed in portions at varying time intervals depending on the registered information carrier.

5. A method according to claim 1, wherein the method further comprises the following step:
the conveyor mechanism advances a fixed amount of feed per time unit depending on the registered information carrier.

6. A method according to claim 1, wherein the method further comprises the following step:
the control unit controls the conveyor mechanism to the effect that conveyance of feed is discontinued when maximal feed dispensing per time unit for an information carrier has been reached.

7. A method according to claim 1, wherein the method further comprises the following step:
the control unit introduces a period of discontinued conveyance of feed in case of repeated shifts in registration of information carrier at a trough within a predetermined period of time.

8. A method according to claim 1, wherein the feed dispenser comprises at least two feed containers and at least two conveyor mechanisms; wherein the method comprises the following further step:
the control unit advances feed via two or more conveyor mechanisms to a feeding trough.

9. A method according to claim 1, wherein the memory of the control unit is stored on a central server.

10. A method according to claim 1, wherein the method comprises the following further step:
conveyance of feed to one information carrier takes place asynchronously at a minimum of two independent troughs.

11. A feed dispenser comprising at least one registration device, an electronic programmable control unit with memory, at least one feed container, at least one conveyor mechanism, a feed site comprising a trough, wherein the one or more conveyor mechanism(s) is/are capable of advancing feed from one or more feed containers to the trough, wherein the feed site is arranged in such a manner that an animal has an escapeway throughout the entire feeding process thereby enabling the animal to leave the trough at any point in time.

12. A feed dispenser according to claim 11, wherein the feed dispenser has an interrupter mechanism allowing the control unit to interrupt the conveyor mechanism.
